(19) United States
(12) Patent Application Publication
(10) Pub. No.: US 2013/0280973 A1
(43) Pub. Date: Oct. 24, 2013

(54) FLOATATION DEVICE FOR PIPE

(71) Applicant: NEPTUNE FLOTATION, LLC, Indianapolis, IN (US)

(72) Inventors: Andrew W. Elder, Zionsville, IN (US); Alex B. Berezhnev, Indianapolis, IN (US)

(21) Appl. No.: 13/866,242

(22) Filed: Apr. 19, 2013

Related U.S. Application Data
(60) Provisional application No. 61/635,622, filed on Apr. 19, 2012.
(60) Provisional application No. 61/677,276, filed on Jul. 30, 2012.

(51) Int. Cl. F16L 1/24

(52) U.S. Cl. CPC F16L 1/24
USPC 441/133

(57) ABSTRACT

A float assembly including at least one float member securable to an elongate conveyance wherein the float members are nestingly stackable when not in use. In another form, the float assembly includes two float members wherein each of the float members define a radially inward facing generally arcuate surface having one or more clamping members extending radially inward wherein securement of the two float members to a generally cylindrical conveyance engages the clamping members with the conveyance. The float members may also include an alignment projection and recess wherein the alignment projections of each of the float members are inserted into the alignment recesses of the opposing float member when the float members are secured about a conveyance. In another form, the float assembly includes at least one float member having a plurality of projections which define openings for the fork of a forklift.

### CROSS REFERENCE TO RELATED APPLICATIONS

This application claims priority under 35 U.S.C. 119(e) of U.S. provisional patent application Ser. No. 61/635,622 filed on Apr. 19, 2012 entitled FLOATATION DEVICE FOR PIPE and U.S. provisional patent application Ser. No. 61/677,276 filed on Jul. 30, 2012 entitled FLOATATION DEVICE FOR PIPE the disclosures of which are both hereby incorporated herein by reference.

### BACKGROUND OF THE INVENTION

1. Field of the Invention

The present invention relates to floatation devices for elongate conveyances such as pipes, hoses and cables.

2. Description of the Related Art

In some situations, hoses and pipes are used to transport liquids, slurries and other mixtures across a body of water. It is often desirable to have the transporting hose or pipe float on the surface of the water or other liquid when performing such transport. Similarly, it is often desirable to route electrical cables across a body of water.

One common application where such floating pipelines are used is in dredging operations. A variety of different floatation devices have been developed for maintaining an elongate conveyance such as a pipe, hose or cable at the surface (most commonly), above the surface, below the surface or at the bottom of the body of water, however, further improvements in such flotation devices are desirable.

### SUMMARY OF THE INVENTION

The present invention provides a floatation device for an elongate conveyance which can be easily and conveniently stacked when it is removed from the pipe, hose or cable for storage or transport to a new location. Also disclosed is a floatation device having a means for gripping the conveyance to prevent shifting of the floatation device on the conveyance during use.

The invention comprises, in one form thereof, a float assembly securable to an elongate conveyance and storable on a horizontal ground surface when not in use. The float assembly includes at least one float member securable to the conveyance wherein the float member defines a longitudinal axis, a radially inward facing generally arcuate surface and an outward facing support surface disposed opposite the arcuate surface. The support surface is engageable with the ground surface to stably support the float member with the arcuate surface facing upward and wherein a plurality of float members having the same configuration as the at least one float member are nestingly stackable on the at least one float member when the support surface of the at least one float member is engaged with the ground surface.

The invention comprises, in another form thereof, a float assembly securable to an elongate conveyance and storable on a horizontal ground surface when not in use. The float assembly includes at least one float member securable to the conveyance wherein the float member defines a longitudinal axis, a radially inward facing generally arcuate surface and at least three projections wherein engagement of the at least three projections with the ground surface stably supports the float member on the ground surface with the arcuate surface facing downward. A plurality of float members having the same configuration as the at least one float member are nestingly stackable on the at least one float member when the at least three projections of the at least one float member are engaged with the ground surface. The at least three projections also define at least one laterally extending passage for receiving a pair of forks of a fork lift and when the at least three projections of the least one float member are engaged with the ground surface.

The invention comprises, in yet another form thereof, a float assembly securable to an elongate conveyance and storable on a horizontal ground surface when not in use. The float assembly includes at least one float member securable to the conveyance wherein the float member defines a longitudinal axis and a radially inward facing generally arcuate surface. The at least one float member is stably positionable on the ground surface and a plurality of float members having the same configuration as the at least one float member are nestingly stackable on the at least one float member when the at least one float member is positioned on the ground surface. The float member also defines at least one handhold adapted to be gripped by a human hand.

In some embodiments, the radially inward facing arcuate surface defines an outwardly flaring section on each longitudinal end of the at least one float member and the at least one handhold comprises a recess in each of the outwardly flaring sections.

The invention comprises, in still another form thereof, a float assembly securable to an elongate, substantially cylindrical, conveyance. The float assembly includes first and second float members having substantially the same configuration wherein the first and second float members are securable together to thereby attach the first and second float members to the conveyance. Each of the first and second float members define a longitudinal axis and a radially inward facing generally arcuate surface and have at least one clamping member projecting radially inwardly from the arcuate surface. Securement of the first and second float members to a conveyance engages the clamping members with the conveyance with the arcuate surfaces of the first and second float members being spaced therefrom. Each of the first and second float members also include at least one projection and at least one cooperating guide wherein the at least one projection of the first float member is engageable by the at least one cooperating guide of the second float member and the at least one projection of the second float member is engageable by the at least one cooperating guide of the first float member. Engagement of the projections with the cooperating guides orients the first and second float members relative to each other as the arcuate surfaces of the first and second float members are moved toward each other during securement of the first and second float members to the conveyance.

In some embodiments, each of the first and second float members includes at least three projections and at least three cooperating guides wherein engagement of the at least three projections of a respective one of the first and second float members with a horizontal ground surface stably supports the one float member on the ground surface with the arcuate surface facing downward and wherein a plurality of float members having the same configuration as the first and second float members are nestingly stackable on the one float member when the at least three projections of the one float member are engaged with the ground surface. In still other embodiments, the guides are formed by guide openings in the float member wherein the guide openings are shaped to slidably receive the projections.

The invention comprises, in another form thereof, a float assembly securable to an elongate, substantially cylindrical, conveyance. The float assembly includes first and second float members having substantially the same configuration wherein the first and second float members are securable together to thereby attach the first and second float members to the conveyance. Each of the first and second float members defining a longitudinal axis and a radially inward facing generally arcuate surface. Each of the first and second float members also include at least one clamping member projecting radially inwardly from the arcuate surface wherein securement of the first and second float members to the conveyance engages the clamping members with the conveyance with the arcuate surfaces of the first and second float members being spaced therefrom. Each of the clamping members have a non-slip surface for engagement with the conveyance to resist rotation of the first and second float members relative to the conveyance. The assembly also includes at least one removable accessory wherein at least one of the first and second float members defines an attachment interface, the accessory being removably securable to the attachment interface.

In some embodiments, the accessory includes an elongate pole extending outwardly from the float member. In such embodiments, the clamping members advantageously include a rubber material which defines the non-slip surface of the clamping members.

The invention comprises, in another form thereof, a float assembly securable to an elongate, substantially cylindrical, conveyance. The float assembly includes first and second float members having substantially the same configuration wherein the first and second float members are securable together to thereby attach the first and second float members to the conveyance. Each of the first and second float members define a longitudinal axis and a radially inward facing generally arcuate surface. Each of the first and second float members also include at least one clamping member projecting radially inwardly from the arcuate surface wherein securement of the first and second float members to a conveyance engages the clamping members with the conveyance with the arcuate surfaces of the first and second float members being spaced therefrom. Each of the first and second float members also define a reinforcing structure disposed proximate at least one of the clamping members.

In some embodiments, the float members comprise a substantially rigid material layer defining a hollow structure and the reinforcing structures includes at least one depression in the rigid material layer. The at least one depression can take the form of two oppositely disposed depressions, one depression formed in the arcuate surface and the other depression formed in an exterior surface of the float member. In still other embodiments, at least a portion of an engagement surface of at least one clamping member is disposed radially inwardly of at least a portion of a respective one of the reinforcing structures. In still other embodiments, each reinforcing structure is disposed between the arcuate surface and an exterior surface of the float member and resists relative movement of the arcuate surface and the exterior surface toward each other, in other words, it resists deformably compressing the float member at the location of the reinforcing structure.

The invention comprises, in yet another form thereof, a float assembly securable to an elongate conveyance and storable on a horizontal ground surface when not in use. The float assembly includes at least one float member securable to the conveyance and stably positionable on the ground surface wherein the float member defines a longitudinal axis, a radially inward facing generally arcuate surface and a radially outwardly facing exterior surface having a generally arcuate shape disposed opposite the inward arcuate surface. The exterior surface defines at least one nesting recess. A plurality of float members having the same configuration as the at least one float member are nestingly stackable on the at least one float member wherein for each adjacent pair of stacked float members, one of the float members of the pair engages the nesting recess of the other float member of the pair to thereby stably engage the pair of adjacently stacked float members.

In some embodiments, the nesting recess includes a longitudinally extending recess. In still other embodiments, the longitudinally extending recess takes the form of a pair of symmetrically disposed longitudinally extending nesting recesses.

For embodiments having a pair of symmetrically disposed longitudinally extending nesting recesses, the float members may also include a pair of longitudinally extending intermediate surfaces extending between the exterior surface and the arcuate surface such that the intermediate surfaces are each engageable with one of the longitudinally extending nesting recesses of an adjacently stacked float member. In such an embodiment, the longitudinal recess can include a protrusion engageable with a corresponding recess in the intermediate surface of the other float member to thereby resist longitudinal movement between the pair of adjacently stacked float members.

Several advantageous features are described herein for use with float members and assemblies. Exemplary embodiments are described and illustrated including different combinations of these features. It is noted, however, that such features may be combined in various manners and alternative float members may include such features in combinations not explicitly described herein.

It is also noted that the floatation devices of the present invention can be used with a wide variety of different objects and are not limited to elongate conveyances of any particular materials or dimensions. The present application uses the term elongate conveyance to refer to fluid conveying conduits as well as cables, such as cables formed out of electrically conductive wiring, and any other elongate object to which the disclosed floatation members might be beneficially coupled.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is a perspective view of a float assembly.

FIG. 2 is a partially exploded perspective view of one float member.

FIG. 3 is a partially exploded end view of a float assembly mounted on an elongate conveyance.

FIG. 4 is an end view of three float members nestingly stacked for storage or transport.

FIG. 5 is a side view of three float members nestingly stacked in an alternative orientation.

FIG. 6 is a perspective view of three stacked float members.

FIG. 7 is an exploded perspective view of a clamping member.

FIG. 8 is a cross sectional view of a clamping member.

FIG. 9 is a schematic cross sectional view of a removable cap assembly.

FIG. 10 is an exploded perspective view of a float assembly and a safety flag.

FIG. 11 is a detail view of the attachment interface of FIG. 10.

FIG. 12 is an exploded perspective view of a float assembly and a safety light.

FIG. 13 is a detail view of the attachment interface of FIG. 12.

FIG. 14 is a perspective view of an alternative float member.

FIG. 15 is a detail view of a structural support positioned near a clamping member.

FIG. 16 is another perspective view of the float member of FIG. 14.

FIG. 17 is a detail view of the clamping member and structural support.

FIG. 17A is a schematic cross sectional view of a clamping member insert.

FIG. 18 is a bottom view of the float member of FIG. 14.

FIG. 19 is a cross sectional view of the structural support.

FIG. 20 is a cross sectional view of an alternative structural support.

FIG. 21 is a cross sectional view of another alternative structural support.

FIG. 22 is a schematic cross sectional view of structural supports positioned in an attachment flange.

FIG. 23 is perspective view of a float assembly with a flexible hose secured thereto.

FIG. 24 is a detail perspective view of the bracket securing the flexible hose to the float assembly.

FIG. 25 is a perspective view of the attachment bracket.

FIG. 26 is an end view of the attachment bracket.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE INVENTION

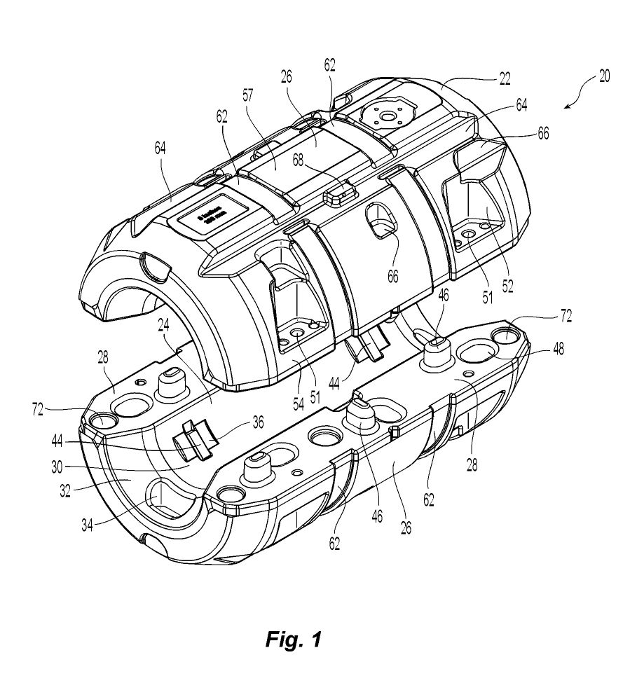

A float assembly 20 can be seen in FIG. 1 and includes two float members 22 which can be secured together about an elongate conveyance. The two float members 22 in the illustrated assembly 20 have the same configuration. While float members 22 are described below in the context of being attached to an elongate conveyance in the form of a pipe 70, float members 22 are not limited to such an application and can be used in many other applications. When using float assemblies 20 with a pipeline, a large number of assemblies 20 are typically employed with a single pipeline. The ability to use a single configuration for both float members 22 in assembly 20 allows the workers attaching float members 22 to the pipeline to grab any two members 22 without having to be concerned about picking a matching pair. If, however, a particular and unique application made it desirable for the members 22 secured together to have different configurations, the present invention could also be employed with a pair of float members 22 having cooperating and differing configurations.

In some applications, it might also be desirable to employ a single floatation member 22 secured to the pipe. For example, straps could be placed in circumferential recesses 62 and around an object to strap a single float member 22 to the object. Alternatively, the float member could be attached to a bracket or some other device by means of bolts extending through openings 51 or by some other suitable method.

Illustrated float members 22 have a hollow interior 79 which is sealed to prevent the ingress of water into the hollow interior. Alternative embodiments of float member 22 may have a sealed interior which is filled with a closed cell foam. The use of a closed cell foam can be advantageous in demanding environments. By filling the interior volume of float member 22 with a closed cell foam, the interior volume of float member 22 will not fill with water if the exterior skin of float member 22 is punctured or otherwise develops a leak. As a result, the punctured or otherwise damaged float member 22 will likely still provide a buoyant lift to the pipeline. The use of such closed cell foam increases the cost of manufacture and, unless the float member 22 is expected to be used in a damaging environment, it will generally be preferable for float member 22 to have a hollow and sealed interior filled only with air.

In the illustrated embodiment, float members 22 are formed out of a polyethylene material using a conventional rotational molding process. Various other materials and manufacturing methods, e.g., blow molding, may also be used to manufacture float members 22.

It is noted that recesses 72 in float member 22 are a result of the manufacturing process and correspond to vent openings in the mold used to form float member 22 when using a conventional rotational molding process. When the manufacturing process leaves vent openings in the float member 22, the vent openings are typically closed by spin welding a circular plate in the opening to thereby seal and permanently close the opening and form recesses 72. When the float interior is filled with foam, the foam can be conveniently introduced into the float member 22 through one of the vent openings before permanently closing the vent opening. A plate installed in recess 72 by spin welding will be permanently fixed therein and cannot be removed through non-destructive means.

FIG. 9 shows an alternative method of sealing a vent opening using a detachable cap assembly 74. The detachable cap assembly 74 includes a rubber cap 76, a metal ring 78 (for example, a brass ring) and a circular sealing member 80. Assembly 74 may take the form of a gas cap assembly for a marine fuel tank. To install assembly 74, sealing member 80 is positioned in the vent opening and then brass ring 78 is press-fit into sealing member 80 compressing sealing member 80 between ring 78 and float member 22 and thereby forming a fluid tight seal. Brass ring 78 includes threads on its interior surface which sealingly engage with exterior threads on cap 76. When cap 76 is threaded into engagement with ring 78, cap assembly 74 closes the vent opening and forms a fluid tight seal. Cap 76 can also be removed from ring 78 to provide access to the interior of float member 22 and then reattached to ring 78 to reseal the opening. The use of a removable cap 76 provides a durable seal for the vent opening. It also allows for the easy removal of any fluids that enter the interior of float member 22 in the event that float member 22 develops a leak at any location.

Another advantage provided by removable cap 76 is that it allows float member 22 to be converted between a sinker and a float. For example, it is sometimes desirable for dredging lines or other piping applications to be run along the bottom surface of a body of water instead of floating the pipes near the water surface, e.g., above, at, or just below the surface. In still other applications, e.g., mining operations, it may be desirable to maintain an elongate conveyance in a vertical orientation wherein the conveyance extends through the water column from below or near the bottom of the water body to near or above the water surface.

When it is desired to weight the pipe to lower its position in the water column, cap 76 can be removed, the interior of float member 22 can be filled with ballast, such as sand, (either completely or partially) and then cap 76 can be reattached. By filling a plurality of such float members 22 with sand or other ballast material and attaching them to the piping, the piping can be weighted down and held at a desired level in the water column, e.g., at the bottom surface of the body of water. The floats 22 can later be reconverted to floats by removing cap 76, emptying the ballast from the interior of float 22 and reattaching cap 76. It is possible to provide multiple removable caps on a single float, e.g., to close each vent opening. It will, however, generally only be necessary to provide a single removable cap assembly 74.

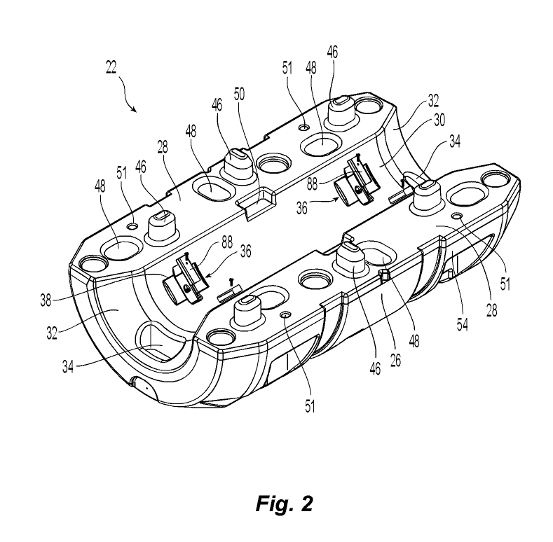

The illustrated float members 22 each have a generally semi-cylindrical shape and, when secured together to form assembly 20, define a generally cylindrical tubular structure with a central bore extending through assembly 20. As can be seen in FIGS. 1 and 2, float member 22 has a radially inward facing surface 24, an exterior surface 26 and intermediate surfaces 28.

Inward facing surface 24 has a semicylindrical portion 30 and outwardly flaring sections 32 at the two opposite longitudinal ends of float member 22. In the illustrated embodiment, a recess 34 is located in each of the outwardly flaring sections 32 to form handholds which facilitate the manual handling of float members 22. Alternative embodiments may include one or more handholds formed on float member 22 in alternative locations and/or having a different configuration to facilitate handling. Although handholds 34 which are formed by a recess and have a size and shape adapted to be easily gripped by an adult hand may vary in size and configuration, it is noted that a recess having a depth of approximately 1 to 3 inches (2.5 to 7.6 cm) and width of approximately 6 inches (15.2 cm) and a slight curve provides an acceptable handhold.

It is also noted that by positioning handholds 34 in outwardly flaring surfaces 32, a person can readily reach handholds 34 regardless of whether or not the float 22 is in the middle of a stack of float members 22. In this regard, it is noted that each outwardly flaring surfaces 32 define an increasingly larger radius as the surface 32 progresses outward toward a respective one of the distal ends of float member 22. In other embodiments, it is noted that the use of such an outwardly flaring section 32 would also ensure access to a handhold on exterior surface 26 proximate the distal ends of float members 22.

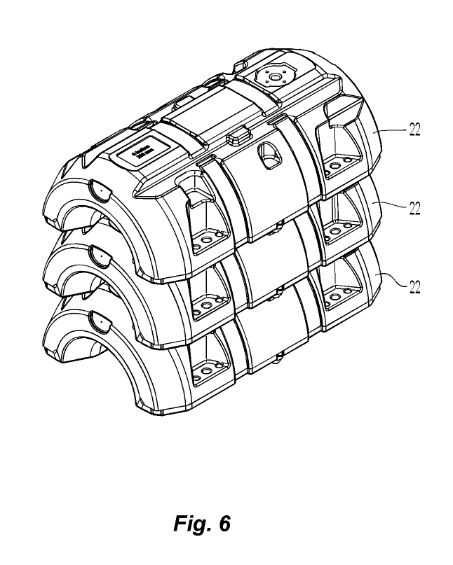

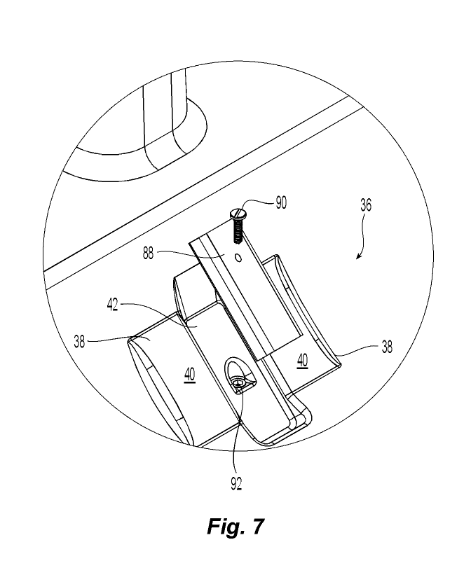

Inward facing surface 24 includes four clamping members 36. As can be seen in FIG. 7 each of the clamping members 36 is formed by raised portions 38 which project radially inwardly relative to semicylindrical portion 30. In the illustrated embodiment, each clamping member includes two raised portions 38 have a substantially planar inward facing surface 40 and a recess or slot 42 disposed between the raised portions 38. When float members 22 are engaged with a cylindrical conveyance, surfaces 40, instead of semicylindrical portion 30, will engage the conveyance. The use of four clamping members 36 on each of the float members 22 define definite areas of contact between the float members 22 and the pipe and facilitate a firm engagement between float member 22 and the pipe. If desired, a texture could be employed on surface 40 to enhance the gripping ability of surface 40.

While the vast majority of conveyances will have a generally cylindrical shape, it would also be possible to employ float members 22 with elongate objects having non-cylindrical shapes. Depending upon the particular shape of such objects and the extent to which clamping members 32 project radially inwardly, it would also be possible to engage such non-cylindrical objects surface 40 while still maintaining surface 30 at a distance from the elongate conveyance.

It is noted that radially inward facing and generally arcuate surface 24 is a partial cylinder in the illustrated embodiments, alternatively shaped radially inward facing and generally arcuate surfaces could also be employed. For example, surface 24 could be formed out of a plurality of planar sections which in their overall shape allow them to a generally arcuate shape that partially encircles a cylindrical pipe. Similarly, exterior surface 26 takes the form of a partial cylinder in the illustrated embodiment but could take the form of a generally arcuate surface formed out of planar sections. While the general shape of surface 24 is configured to cooperate with an elongate conveyance such as pipe 70, exterior surface 26 is not subject to the same design factors as surface 24 and, in alternative embodiments, exterior surface 26 could vary significantly from the illustrated configuration which has an overall shape with a generally arcuate configuration.

Also shown in FIG. 7 is an optional insert 88. The illustrated insert 88 is positioned in slot 42 and projects radially inwardly relative to surfaces 40 whereby it will engage the pipe instead of surfaces 40. Insert 88 may be formed out of a material such as rubber which will enhance the gripping engagement of the pipe by providing greater frictional resistance to movement between the pipe and float member 22 when the float member 22 is installed thereon. The insert may be held within slot 42 by a press-fit engagement or it may be attached with an adhesive or other suitable means. Various other alternative embodiments of the insert may also be used with float member 22. For example, insert 88 may have only a layer of rubber forming the engagement surface instead of being a solid rubber insert.

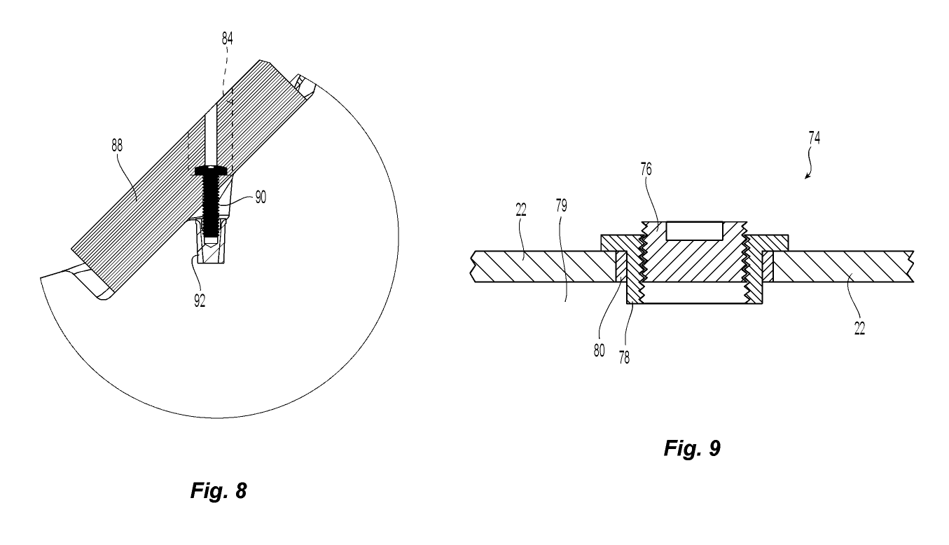

FIGS. 7 and 8 illustrate the attachment of an insert 88 formed by extruding a rubber material. The extruded material is cut to length and a hole is drilled through insert 88. A machine screw 90 is then inserted through the hole when attaching insert 88 to a float member 22. The resiliently deformable material used to form insert 88 allows the head of fastener 90 to be recessed below the upper surface of insert 88 without using an enlarged diameter counterbore in insert 88. It would, however, also be possible to form such a counterbore in insert 88. FIG. 8 schematically depicts in dotted outline 84 the structure of such a counterbore.

As best seen in FIG. 8 float member 22 may be provided with an insert 92 having an internal thread to engage threaded fastener 90. In the illustrated embodiment, threaded insert 92 is installed after molding float member 22, however, inserts 92 could also be molded into place. The illustrated inserts 92 are formed out of a metal material and have external threads which allow the inserts 92 to be screwed into float member 22. The illustrated float members 22 have a wall thickness of approximately 0.25 inches (0.64 cm) and the area in which inserts 92 are installed can be provided with a greater thickness. The illustrated inserts 92 are each positioned in a slot 42 and do not fully penetrate the wall of float members 22. Alternative configurations of a threaded aperture to receive a fastener for securing a gripping insert 88 may also be employed.

As mentioned above, alternative methods of securing an insert can also be employed with float members 22. For example, insert 44, shown in FIG. 1 does not include a hole for receiving a fastener and can be press-fit or adhesively secured within slot 42. It would also be possible to attach a rubber insert by molding it into float member 22. In this regard, it is noted that a molded in insert would be permanently attached and could not be non-destructively removed. It will generally not be desirable to remove inserts 44, 88 from float members 22 once the inserts have been attached. Due to the use of threaded fasteners 90, inserts 88, however, could be removed and replaced if damaged. Similarly, a press-fit secured insert 44 or 88 could be non-destructively removed from float member 22.

While the illustrated gripping insert 88 is an extruded insert, alternative inserts could be formed by other means such as injection molding. For example, the use of injection molding would allow insert 88 to have an opening for fastener 90, with or without a counterbore 84, formed during the molding process. Various other materials and methods of manufacture can also be used to form gripping inserts for use with floatation members 22.

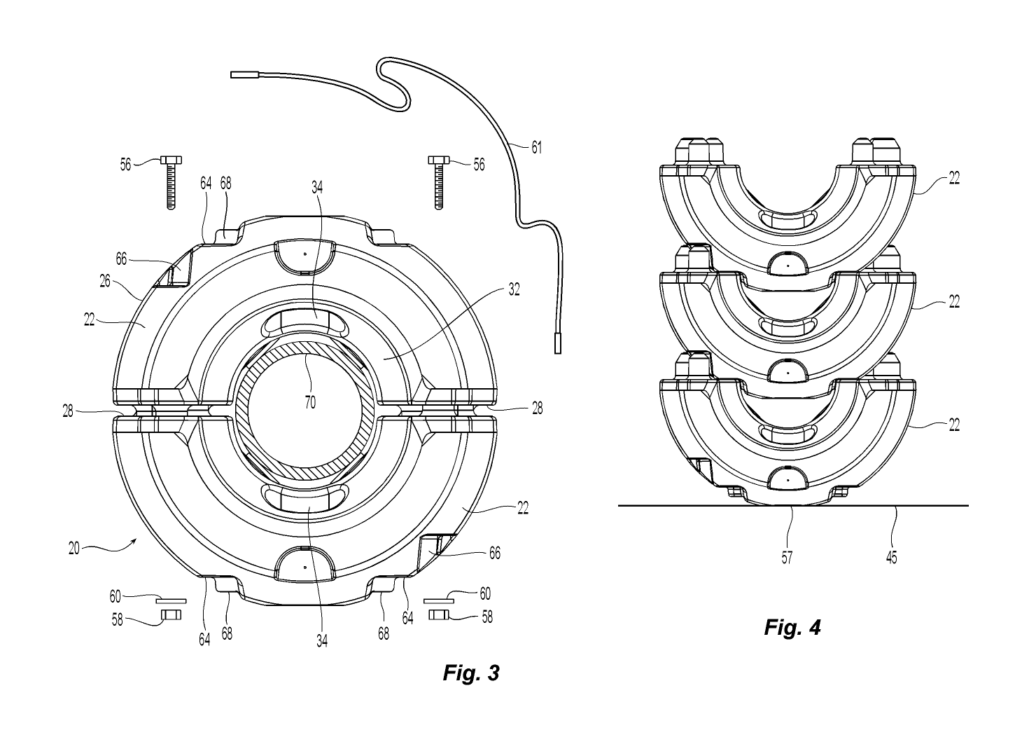

Intermediate surfaces 28 extend the longitudinal length of float members 22 and include projections 46 and cooperating guide recesses 48. When two float members 22 are engaged with a pipe 70 as depicted in FIG. 3, each of the projections 46 on the float members 22 are slidingly inserted into one of the recesses 48 in the opposing float member 22. The engagement of the projections 46 with cooperating guides 48 aligns the two float members when securing them together about pipe 70.

The interfitting of projections 46 with recesses 48 prevent relative movement of the two engaged float members 22 in a plane parallel with surfaces 28. In other words, it prevents longitudinal and lateral displacement of the two float members 22 but allows surfaces 28 to move toward and away from each other while remaining parallel to each other. In this regard, it is noted that the illustrated embodiment employs substantially oval shaped projections 46 and the projections 46 located nearest the center of the float members 22 have their larger surfaces positioned to resist movement parallel to the longitudinal axis of the pipe while the projections 46 nearest the ends of the float members 22 have their larger surfaces positioned to resist lateral movement perpendicular to the longitudinal axis. All of the illustrated projections 46, however, resist relative movement between the engaged float members 22 in both the longitudinal and lateral directions. Although the illustrated guide recesses 48 completely encircle projections 46 in the illustrated embodiment, it would also be possible to use alternative configurations where the cooperating guides did not fully encircle the projections but still maintained the proper orientation of the two float members 22 being secured together. It is also noted that the disclosed embodiments advantageously employ projections 46 to also lift the float members 22 above the ground surface 45 in a manner that facilitates the use of a fork lift with float members 22. Although it generally would not be advantageous, alternative embodiments could be configured to use separate projections for these two different functions.

The two float members 22 are secured together by inserting bolts 56 through bolt holes 51 and attaching nuts 58 to bolts 56. Washers 60 may also be used when securing the nuts 58 and bolts 56. As bolts 56 are tightened, projections 46 are inserted deeper into recesses 48 until either clamping surfaces 40 or optional clamping inserts 44 engage the outer diameter of pipe 70. Float members 22 are configured so that when float members 22 are secured on a pipe 70, surfaces 28 on the opposing float members 22 will be spaced apart. In this regard, it is noted that differently sized float members 22 will be manufactured with each different size of float member 22 being securable on a range of pipe sizes and surfaces 28 will remain spaced apart when float members 22 are secured on a pipe unless the float members 22 are secured about a significantly undersized pipe.

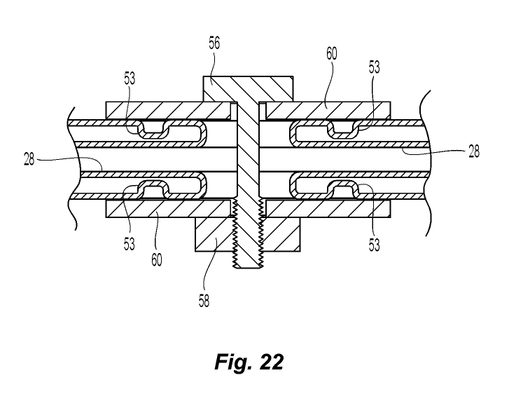

To provide enhanced strength to floatation members 22 at the location of bolt holes 51 and thus inhibit local deformation of the float members due to tightening of the bolts, at least one kiss-off or reinforcing structure 53 may be disposed proximate each of the cooperating openings 51 of the two float members 22 being secured together. The use of kiss-offs and almost kiss-offs when blow molding or rotationally molding a part is well-known to those having ordinary skill in the art. A kiss-off is formed when two walls of a part come together in a limited area. An almost kiss-off leaves a small gap between the two walls. Both kiss-offs and almost kiss-offs can be used to enhance the strength of the part by acting as a reinforcing structure in a manner similar to stiffening ribs. Advantageously, washers transmitting the clamping forces would extend over the location of the reinforcing structures 53 as schematically depicted in FIG. 22.

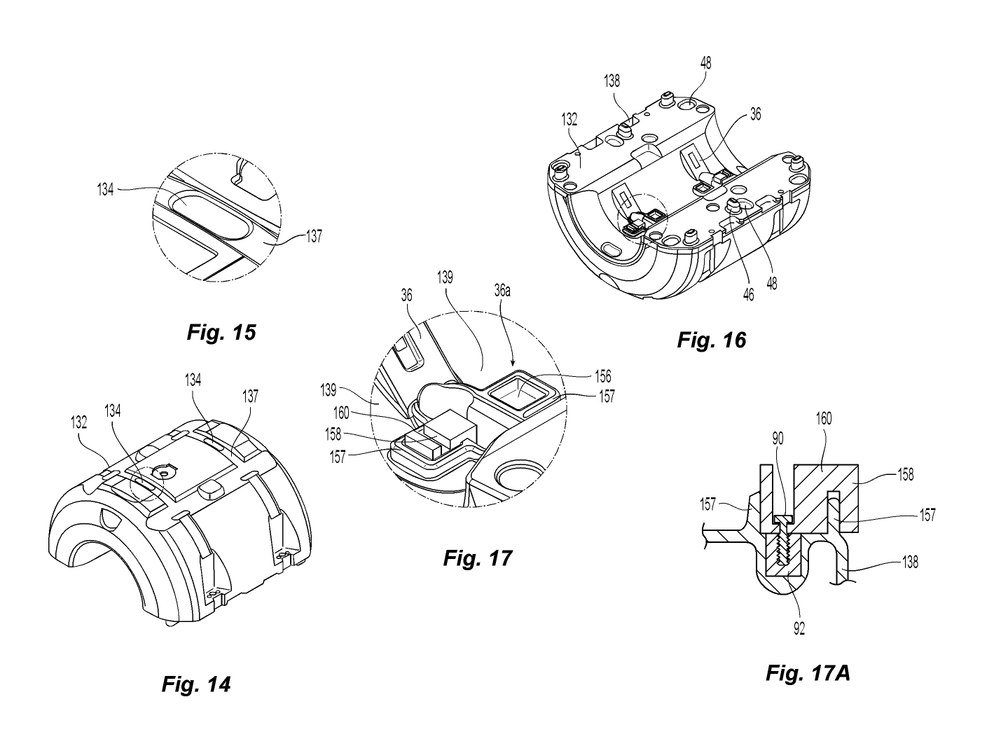

Float member 132 depicted in FIGS. 14-18 utilizes a similar reinforcing structure proximate one or more of the clamping members of float member 132. Reinforcing structure 134 is disposed proximate a clamping member to reinforce float member 132 at a location where stresses are relatively high due to the pressure exerted by the clamping member.

Float members 132 include clamping members 36 similar to those found in float members 22 but also include an additional clamping member 36a formed by recesses 156 which are each defined by a projecting lip 157. An insert 158, which is advantageously formed out of rubber or a similar material, is secured in recess 156. Insert 158 has a radially inward facing surface 160 that is positioned to engage an elongate conveyance and resist slipping. Insert 158 with its non-slip surface 160 can be secured in recess 156 by a press fit engagement, adhesives, fasteners or other suitable method.

As best seen in FIGS. 17 and 17A, the illustrated insert 158 includes two oppositely facing slots. Insert 158 is positioned so that one slot faces radially inward and allows a threaded fastener 90 to be engaged with insert 92 to secure insert 158 to float member 132 with the head of fastener 90 being positioned below surface 160. The other slot faces in the opposite direction and is slipped over lip 157 with a portion of insert 158 positioned radially inwardly of a portion of sidewall 138. The positioning of a portion of insert 158 radially inwardly of a portion of sidewall 138 as depicted in FIG. 17A allows for the relatively direct transfer of forces from surface 160 to sidewalls 138 of reinforcing structure 134.

Apart from its proportionally shorter longitudinal length, alternative clamping member configuration and reinforcing structure 134, float member 132 is generally similar to float member 22 and can be manufactured in the same manner as described above with reference to float members 22. In other words, float member 132 takes the form of a substantially rigid and hollow structure. Float member 132 is rigid in that it generally retains its shape under normal use conditions. It may, however, also have some resilience whereby an impact may temporarily deform the shape of the float. Reinforcing structure 134 takes the form of a depression in the material layer 135 forming the hollow structure of float member 132 to thereby function in a manner similar to depression 53.

Reinforcing structure 134 can take the same configuration as element 53 shown in FIG. 22 or take the form of the depressions shown in FIGS. 19-21. FIG. 19 illustrates a first variant 140 of the reinforcing structure which includes a smaller diameter depression extending into the float from the exterior of float member 132 and a larger diameter depression extending into the float from the radially inward facing surface of float 132. The smaller diameter depression is defined by sidewalls 136 which terminate at bottom wall 142. The larger diameter depression is defined by sidewalls 138 which also terminate at bottom wall 142.

FIG. 20 illustrates a second variant 144 of the reinforcing structure. Reinforcing structure 144 is similar to reinforcing structure 140 but does not include a common bottom wall 142 and instead defines a passage 146 which extends from the interior surface to the exterior surface of float member 132.

FIG. 21 illustrates a third variant 148 of the reinforcing structure. Reinforcing structure 148 is similar to reinforcing structure 140 but instead of having a common bottom wall, has two separate bottom walls. More specifically, the sidewalls 136 of the smaller depression terminate at bottom wall 150 and sidewalls 138 of the larger depression terminate at bottom wall 152. A small gap 154 separates the two bottom walls 150, 152.

As mentioned above, reinforcing structure 134 can take the form of a single depression extending inwardly from one direction only as exemplified by depression 53 or by two separate depressions extending inwardly from opposite directions as exemplified by the embodiments illustrated in FIGS. 19-21. In this regard, it is noted that, for purposes of simplifying manufacture, the use of a single depression will generally be more desirable where the distance between the two opposed outer material layers 135 are relatively small and the use of two depressions extending inwardly from opposite directions will generally be desirable when the distance between the opposed material layers 135 is larger.

Returning now to a discussion of the three different reinforcing structures depicted in FIGS. 19-21, each of these embodiments have depressions which extend inwardly from the opposite disposed material layers 135 forming inward facing surface 24 and exterior surface 26 of the float member 134. The sidewalls 136 which extend inwardly from exterior surface 26 extend toward the opposite float surface, i.e., inward facing surface 24, and generally perpendicularly to the immediately surrounding surface 137 which forms a part of the exterior surface 26. Similarly, sidewalls 138 extend toward exterior surface 26 and at an angle to the immediately surrounding surface 139 which forms a part of radially inward facing surface 24. These substantially transversely extending sidewalls 136, 138 provide enhanced strength to float member 134 proximate the clamping members and thereby enhance the strength and durability of float members 134.

It is additionally noted that while the kiss-off variant 140 of FIG. 19 and the through hole variant 144 of FIG. 20 extend the entire distance between exterior surface 26 and inner surface 24, it is also possible for the reinforcing structure to extend for substantially the entire distance between the two opposed surfaces 24, 26 without extending the full distance as illustrated by the land variant 148 of FIG. 21 which leaves a small gap 154 between the two opposed depressions.

The use of a reinforcing structure proximate a clamping member allows greater forces to be applied to the float member when securing the float member without causing the compression or buckling of the float member proximate the clamping member. This, in turn, allows the clamping member to more securely engage the conveyance. It is noted that deformation of the float member by compression or buckling would typically result in exterior surface 26 being moved closer to arcuate surface 24 and positioning a reinforcing structure 134 between these two surfaces as depicted in FIGS. 19-21 resists such deformation of the float member.

It is additionally noted that while the reinforcing structures illustrated in FIGS. 19-21 are formed at the same time as material layer 135 during the rotational molding of the float member, alternative embodiments and methods of manufacture could also be employed to provide a reinforcing structure for one or more of the clamping members. For example, a separately formed component, e.g., an injection molded polymeric or metal reinforcing structure, could be molded into place in the float member or be installed after molding the main body of the float member.

Projections 46 and guide recesses 48 also enhance the performance the clamping members. One advantage of using projections 46 and recesses 48 in combination with clamping members 36 is that each individual size of float member 22 works with a broad range of pipe sizes in contrast to a float member having a substantially cylindrical surface that engages the pipe. The use of clamping members 36 to grip pipe 70 instead of semi-cylindrical surface 30 allows for a greater difference between the outside diameter of pipe 70 and the diameter defined by surfaces 30. The use of interfitting projections 46 and recesses 48 also facilitates the use of float members 22 with a broader range of pipe sizes by providing resistance to relative movement between the float members 22 over a range of distances separating opposing surfaces 28.

One particularly useful aspect of this enhanced functionality is that a single float assembly 20 can be used with pipes that conform to either the English or metric measuring system. Oftentimes, pipes which conform to the English measuring system have a metric counterpart that is very similar in size but differs slightly. Clamping members 36 and the interfitting of projections 46 and recesses 48 allow the illustrated float members 22 to readily clamp pipes having generally similar diameters but which differ due to their conformance to different measuring systems.

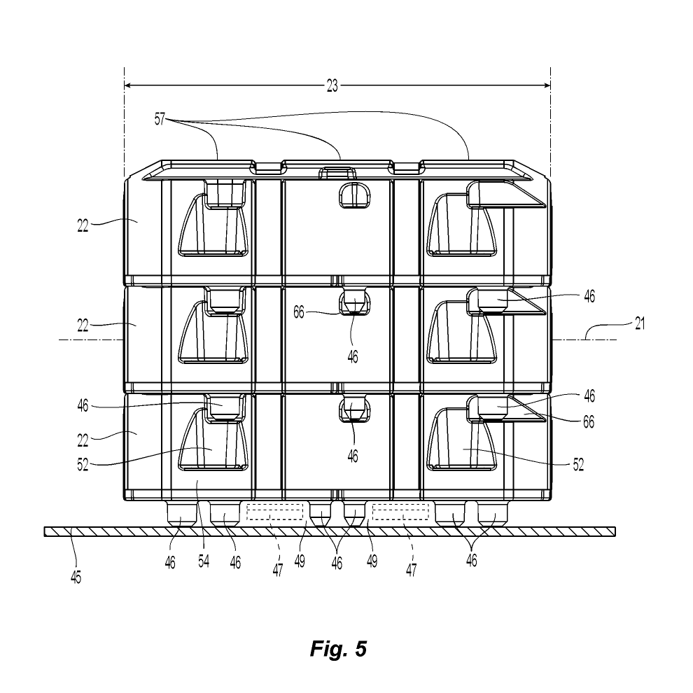

Another advantage provided by projections 46 can be seen in FIG. 5. Float members 22 all define a longitudinal axis 21 (axis 21 is only shown for the middle float member in FIG. 5). As shown, projections 46 lift float member 22 off of the ground when it is not in use and define at least one laterally extending passage 49 which provides clearance for the forks of a forklift. Projections 46 advantageously project at least about one inch from surface 28 to provide sufficient clearance for a forklift and providing a range of spacing distances between surfaces 28 of opposing float members 22. The positioning of projections 46 also advantageously provides openings 49 having a width of least about 4 to 5 inches to allow for the insertion of the two forks 47 of a forklift. Because most forklifts have adjustable forks, the spacing between the two widths is not critical.

Although the illustrated float members 22 each have six projections 46, three on each surface 28, a smaller number could be employed and still allow float member 22 to be stably positioned on a ground surface with projections 46 engaging a horizontal ground surface 45 with only projections 46 engaging the ground and surfaces 28 being positioned substantially parallel with the ground surface. For example, four projections 46, two on each surface 28, would allow float members 22 to be stably positioned on the ground surface. If desired, three projections 46, arranged correctly, could provide stability wherein only the projections 46 engage the ground surface and the float member is stable when additional float members 22 are stacked thereon in a uniform manner positioned directly above the bottom float member 22. It will, however, generally be desirable to use an even number of projections 46 with an equal number of projections being symmetrically positioned on the two intermediate surfaces 28.

It is also noted that the illustrated embodiment has projections 46 which define two separate laterally extending passages 49, one for each fork 47 of a forklift. Alternative embodiments, however, could position projections 46 such that a single larger laterally extending passageway could accommodate both forks of a forklift.

The illustrated float members 22 also have a support surface 57 disposed opposite inward facing surface 24 and positioned at the uppermost position of float member 22 when surface 24 is facing downward. Surface 57 is configured such that float members 22 can be stably positioned with surface 57 engaging the ground surface instead of projections 46. This allows float members 22 to be stacked with the lowermost member 22 oriented “upside down” and with its support surface 57 engaging the ground and the other float members stacked thereon in a similar upside down orientation as shown in FIG. 4. In other words, float members 22 can be selectively stacked in two different orientations. In FIGS. 5 and 6, float members 22 are stacked in a first orientation with their radially inward surfaces 24 facing the ground surface 45, i.e., downward, while in FIG. 4, float members 22 are stacked in a second orientation with their radially inward surfaces 24 facing away from ground surface 45, i.e., upward.

As can be seen in FIG. 5, support surface 57 extends longitudinally for a substantial majority of the longitudinal length 23 of float members 22 as can be seen in FIG. 5. Although the illustrated support surface 57 takes the form of a substantially planar surface having grooves 62 and attachment interface 95 formed therein alternative embodiments are also possible. For example, surface 57 could be broken up into small bearing surfaces while still providing a stable support surface provided that such smaller bearing surfaces were appropriately positioned.

As can be most easily seen in FIGS. 1 and 2, float members 22 include recesses 50 located at the longitudinal midpoint of float member 22 and at the intersection of the inward facing surface 24 and intermediate surfaces 28. Recesses 50 engage interlocking protrusions 68 when stacking float members 22 as will be discussed in greater detail below.

Exterior surface 26 of float members 22 defines a substantially semi-cylindrical surface with several features formed therein. One of those features are recesses 52 which define an attachment ledge 54 through which a bolt hole 51 extends. Exterior surface 26 also defines circumferential grooves 62. Grooves 62 can be used to receive and longitudinally restrain straps 61 when securing float members 22. For example, straps can be used to secure two float members 22 together about a pipe 70 or to secure a single float member 22 to a pipe. The use of straps, e.g., plastic strapping, to secure floatation devices to a pipe is known in the art and such straps can be used instead of, or in addition to, bolts 56 when securing two float members 22 together about a pipe 70.

Exterior surface 26 also defines several features which facilitate the stacking of float members 22 when they are not being used. More specifically, surface 26 defines two longitudinally extending nesting recesses or indentations 64. As most easily seen in FIG. 5, indentations 64 receive and support intermediate surface 28 at the radially inner edge of float member 22. Exterior surface 26 also defines a plurality of nesting recesses 66 which receive projections 46. Extending outwardly proximate the longitudinal midpoint of each indentation 64 is an interlocking protrusion 68. Protrusions 68 are received in recesses 50 located in intermediate surfaces 28 to help secure float members 22 together when members 22 are stacked. The stacking ability of float members 22 provided by these features can be most easily appreciated with reference to FIGS. 1-6.

As can be seen in the figures, the illustrated float members 22, 132, 132a each have a pair of symmetrically disposed longitudinally extending nesting recesses 64 which extend the full longitudinal length of the float members. Engagement of recesses 64 with intermediate surfaces 28 transfers the weight of the stacked float members. The configuration of longitudinal recesses 64 also inhibits the lateral displacement of adjacently stacked float members. The engagement of protrusions 68 and recesses 50 inhibits both the lateral and longitudinal relative displacement of adjacently stacked float members. This functionality is provided regardless of whether arcuate surface 24, and intermediate surfaces 28, is facing upwards (FIG. 4) or downwards (FIG. 5). While it is advantageous to include interlocking protrusions 68 and recesses 50 in float members 22, 132, 132a, it is not necessary to provide nestingly stackable float members.

It is further noted that the engagement of protrusions 46 with recesses 66 in exterior surface 26 can also serve a nesting function. For example, by lengthening protrusions 46, the engagement of protrusions 46 with nesting recesses 66 would both transfer weight between adjacently stacked float members and inhibit both longitudinal and lateral displacement between adjacently stacked float members in the absence of longitudinal recesses 64 and protrusions 68.

The ability to stack float members 22 provides several advantages. Most significantly, the ability to stack float members 22 allows for the convenient storage and transport of the float members. The ability to use a forklift to directly lift a stack of float members 22 also provides significant efficiencies when storing the float members 22 or when transporting the float members between project locations. While projections 46 allow for the use of a forklift directly with float members 22, members 22 may alternatively be stacked on pallets. The ability to stack float members 22 also facilitates the efficient securement of float assemblies 20 on pipes 70.

Oftentimes, pipe floats are assembled on pipes on a dock structure and then the pipe is placed in the water with floats secured thereto. The pipes are then often attached together in the water. When assembling a floating pipeline in this manner, the ability to provide the workers with organized stacks of float members 22 instead of loosely piled floats strewn about the dock facilitates the efficient attachment of floats to the pipes. It is also noted that recesses 52 disposed proximate bolt holes 51 are sized to provide clearance and convenient access to bolt holes 51 and thereby also facilitates the convenient securement of float assemblies 20 on pipes 70.

When attaching float assemblies 20 on pipes 70, the spacing of the float assemblies 20 will depend on the particular buoyancy needed for that application. For example, the weight of the pipe itself will be known and the weight of the substances being transported through the pipe can also be estimated. Obviously, the weight of the pipe will be dependent on its size and the material used to form the pipe. In this regard, it is noted that high density polyethylene (HDPE) pipe are commonly used in floating pipe applications, however, many other types of pipe are also used with such applications such as steel and PVC pipe.

It is also noted that for dredging operations, it is common for the transported mixture to include water and approximately 20% sand and, thus, the weight of the contents of the pipe can be estimated. Similarly, if the pipeline is being used to transport gas or oil, the weight of these fluids can also be estimated in advance. Once the weight of the pipe and its contents are calculated, the required buoyancy, and thus spacing of the float assemblies 20, can be easily determined by a person having ordinary skill in the art.

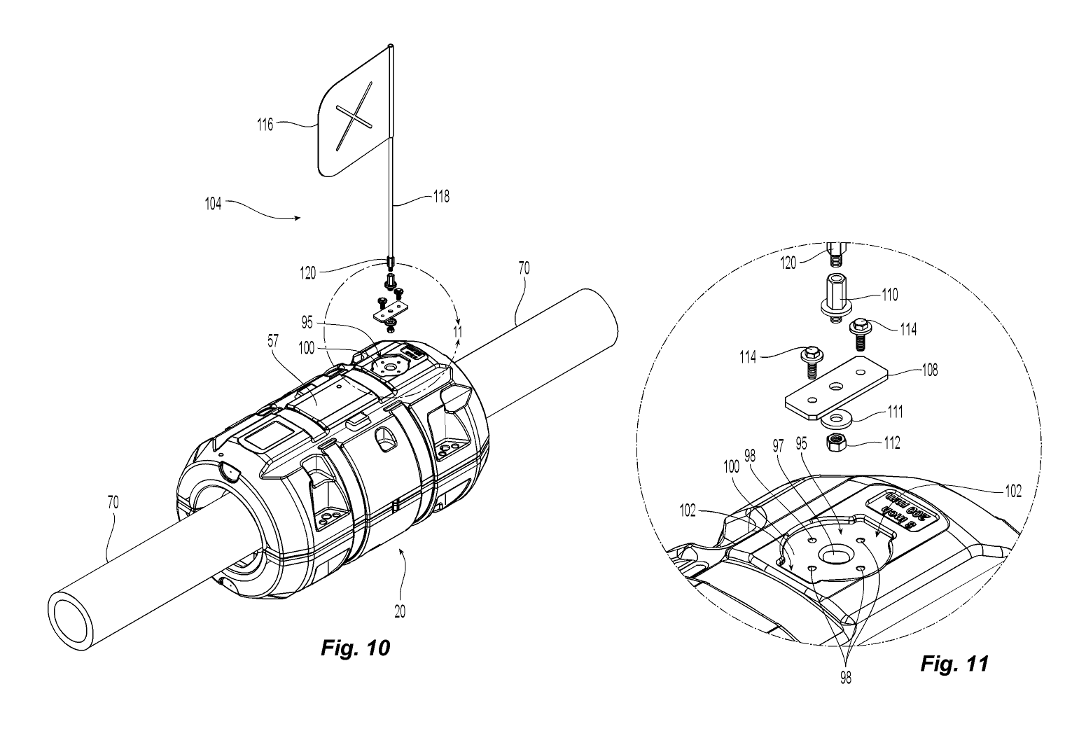

In some embodiments, float members 22 include an attachment interface that allows an accessory to be removably secured to the float member 22. FIGS. 10-13 illustrates a float member 22 having an attachment interface 95 which takes the form of a generally circular depression 100 with outwardly projecting portions 102 that define the four corners of a rectangle. Attachment interface 95 also includes a centrally located cylindrical recess 97 and four threaded inserts 98 for receiving threaded fasteners. The inserts 98 of the illustrated embodiments are brass inserts with internal threads for engagement with threaded fasteners and external threads for secure attachment of the inserts 98 to float members 22. Inserts 98 can be molded into float members 22 or be installed after molding float members 22 and may be made out of various materials, such as brass or stainless steel, appropriate for the environment in which the float member will be used.

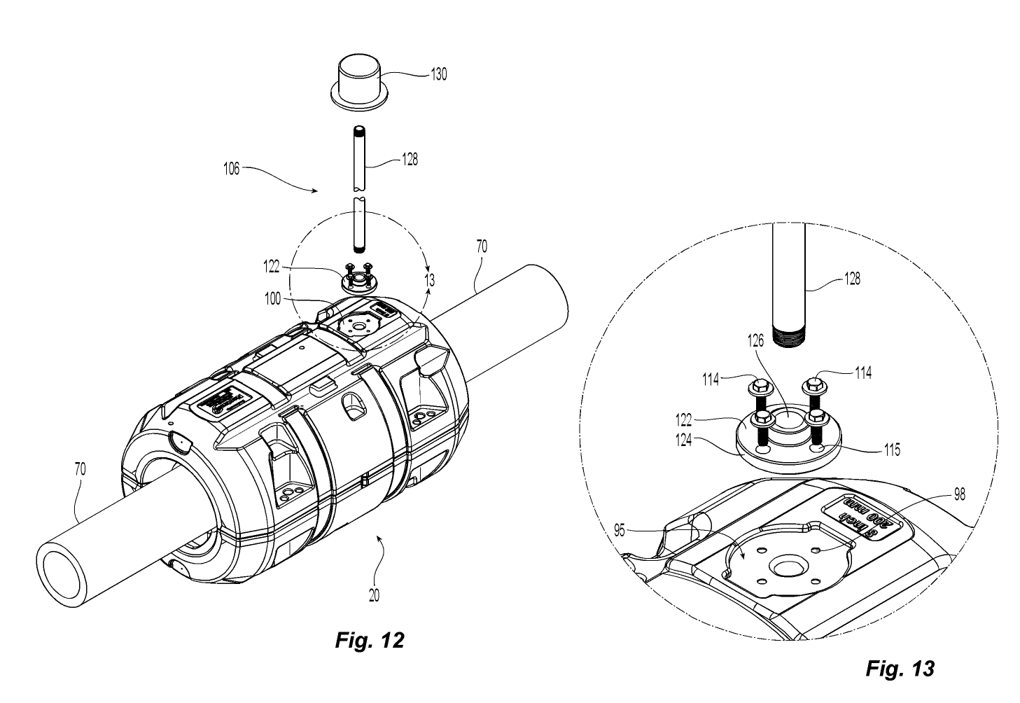

The use of an attachment interface 95 allows accessories such as a safety flag assembly 104 (FIG. 10) or safety light assembly 106 (FIG. 12) to be attached to a float assembly 20. Typically, safety flags and safety lights for floating pipelines are mounted on buoys positioned near the floating pipeline. The use of rubber inserts 44, 88 with float members 22 allows pipe float assembly 20 to tightly grip the pipe and prevent the float assembly 20 from rotating on the pipe when a safety flag assembly 104 or safety light assembly 106 is mounted on the float assembly 20 and thereby keep the flag/light in an upright position. It will generally be desirable to use rubber inserts 44, 88 to enhance the grip of float members 22 when attaching an accessory that must be kept at a particular rotational position on the pipe such as a safety flag or safety light assembly. Depending upon the physical characteristics of the pipe and the weight and dimensions of the accessory, clamping members 36 without rubber inserts may be sufficient to retain float assembly 20 in a desired rotational position on the pipe.

Flag assembly 104 is best seen in FIGS. 10 and 11. The base assembly of the flag unit 104 includes an attachment plate 108 to which is secured a base member 110 having an internally threaded upward opening bore and a downward extending threaded shaft. Plate 108 is advantageously formed out of a stainless steel or hot dipped galvanized material. The threaded shaft of member 110 is inserted through a central opening in plate 108. A radially extending flange on member 110 acts as a washer and bears against the upper surface of plate 108. A lock washer 111 and nut 112 engage the threaded shaft of member 110 and are positioned in recess 97 when plate 108 is secured within depression 100 with its opposite ends extending into rectangular portions 102. Attachment bolts 114 and lock washers are engaged with inserts 98 when securing plate 108 to float member 22. Bolts 114 are advantageously stainless steel or hot dipped galvanized bolts to inhibit corrosion. Safety flag 116 is mounted on a pole 118 having a threaded end 120. Pole 118 may advantageously be formed out of a fiberglass rod having a nominal diameter of ⅜ inch (0.95 cm) or ½ inch (1.3 cm). Threaded end 120 is engaged with the internally threaded bore of base member 110 to secure the safety flag 116 to float member 22. When storing float member 22, flag pole 118 and flag 116 can be detached from float member 22 by unscrewing end 120 from base member 110. In the illustrated embodiment, base plate 108 is a 2 inch (5.1 cm) by 5 inch (12.7 cm) plate and base member 110 projects approximately 2 inches (5.1 cm) from plate 108 and does not interfere with the stacking of float member 22 with other float members 22.

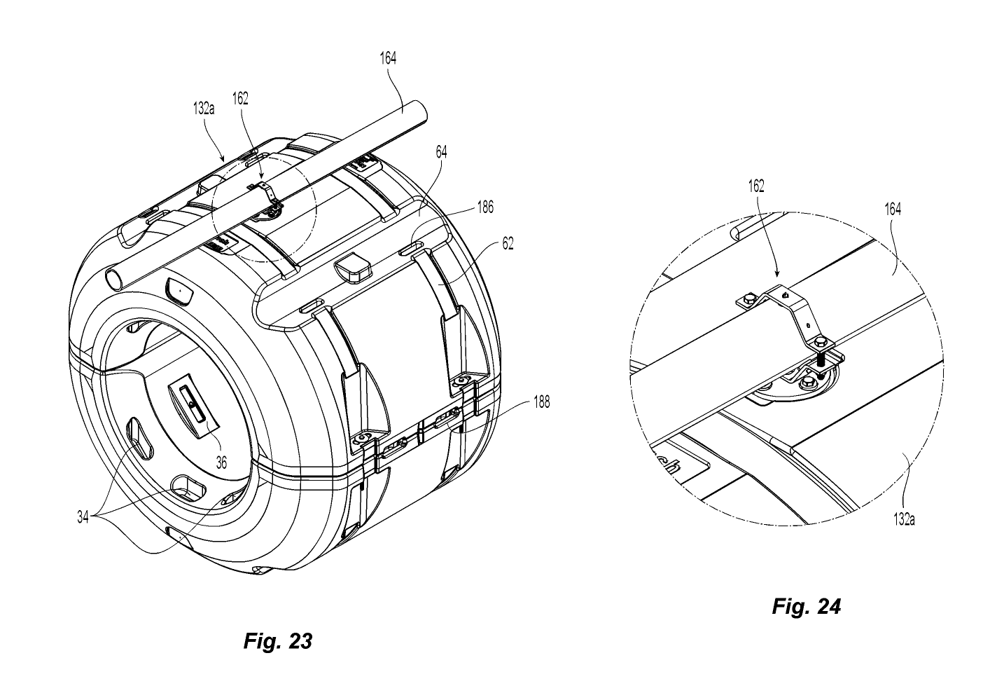

Safety light assembly 106 is best seen in FIGS. 12 and 13. The safety light assembly 106 depicted in FIGS. 23 and 24 has a robust base assembly which includes a one piece attachment flange 122 with a circular base plate 124 and an internally threaded projection 126. Flange 122 may be formed out of a PVC material and have a base plate 124 with a 4 inch (10.2 cm) diameter. Flange 122 is secured within circular depression 100 with four attachment bolts 114 and lock washers. A PVC pipe 128 with threaded ends is used to support a light assembly 130. Pipe 128 can have a nominal diameter of ¾ inch or 1 inch and a length sufficient to position the light at least 1 meter above the water surface. The opposite threaded ends of pipe 128 are screwed into projection 126 and an internally threaded connector on the bottom of light assembly 130. Projection 126 extends approximately ¾ inch (1.9 cm) to 1 inch (2.54 cm) above plate 124 and does not interfere with the stacking of float members 22 when pipe 128 is detached. Safety light 130 is a conventional marine safety light and may be powered by solar cells or battery. For example, suitable safety lights are commercially available from McDermott Light & Signal located in Ridgewood, N.Y.

By providing an attachment interface 95 on float members 22, it will generally be possible to satisfy the applicable Coast Guard regulations or other applicable laws concerning the marking of a floating pipeline by attaching the necessary flags and/or lights directly to float members 22 instead of using separate buoys to support such flags and/or lights. It is noted that the illustrated embodiment uses threaded fasteners to secure base assemblies within recesses in float members 22. Other means of providing base assemblies, however, can also be used when providing float members 22 with an attachment interface. For example, an attachment flange similar to flange 122 could be molded into a float member 22. It is also noted that while two differently dimensioned base assemblies are described above, it is possible to use a standardized base assembly and have each of the accessories, e.g., safety light, safety flag etc., have a common mounting interface which will allow for attachment to the standardized base assembly. Moreover, while only two accessories, i.e., safety flag assembly 104 and safety light assembly 106, are described above, other accessories attachable to float member 22 using attachment interface 95 could also be used with float members 22.

When the accessory 104, 106 includes an elongate support member 118, 128 which extends outwardly from the float member 22, the positioning of a mass at a distance from the float member increases the moment forces acting on the accessory 104, 106 which must be resisted by the engagement of the clamping members 38 with the elongate conveyance, e.g., pipe 70. Of course, if this moment is not resisted and the float members 22 are allowed to rotate relative to pipe 70, the light or flag will end up on the surface of the water instead of extending vertically where it can be seen. To retain the accessories 104, 106 in the desired orientation it is advantageous to utilize clamping members having non-slip surfaces for engagement with the pipe 70 or other conveyance. Such a non-slip surface may be formed by utilizing an appropriate texture or material on surface 40 or by engaging the conveyance with the engagement surface 160 of an insert, e.g., rubber insert.

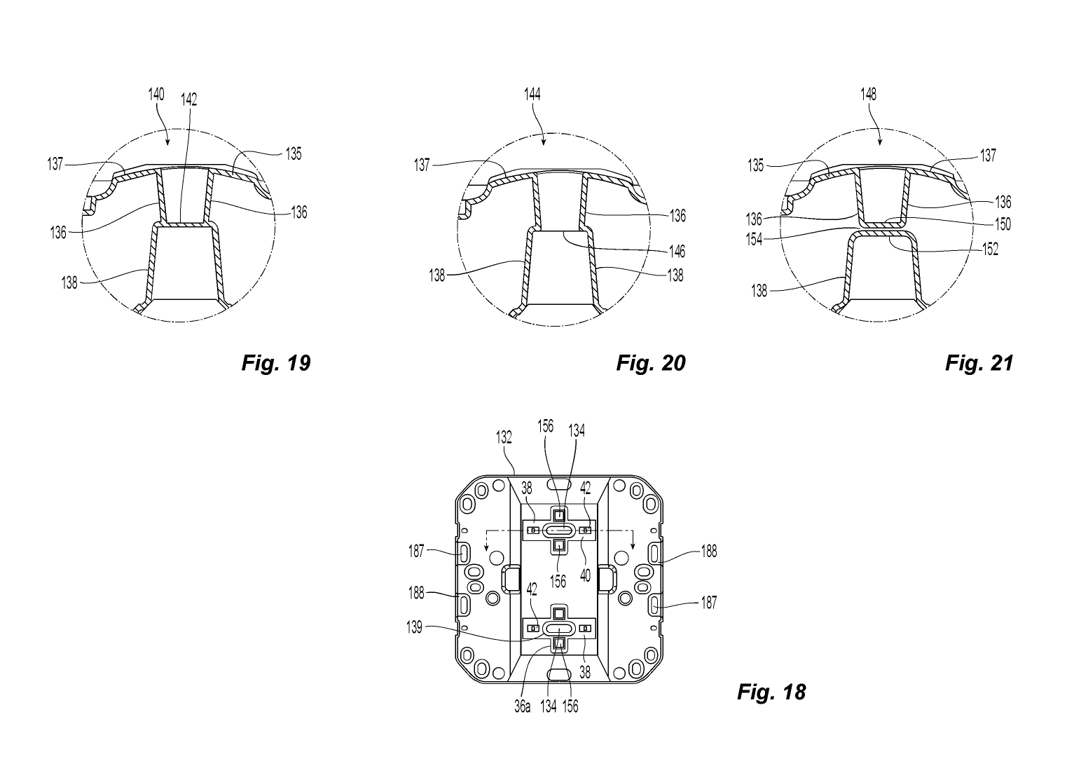

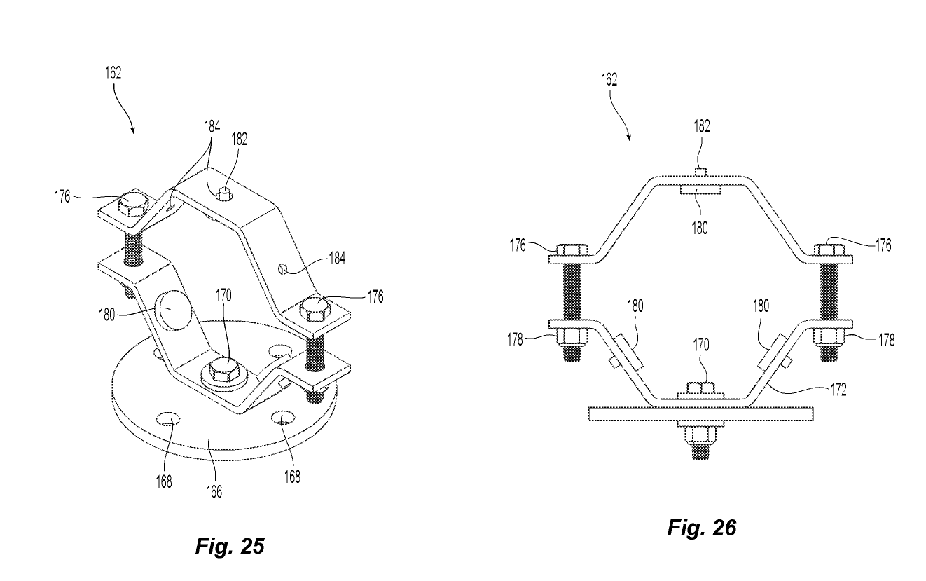

FIGS. 23-26 illustrate the attachment of another accessory to a float assembly using attachment interface 95. The float assembly shown in FIG. 13 includes two float members 132a. Float members 132a are similar to float members 132 shown in FIGS. 14 and 16 but do not include reinforcing structure 134. Float members 132a also differ in that float members 132a include three handholds 34 in outward flaring portion 32 at each longitudinal end of float member 132a. It is additionally noted, that both floats 132 and 132a include recesses or slots 188 in intermediate surface 28 which extend outwardly and also form a recess on exterior surface 26 (FIGS. 18 and 23) with oval shaped depressions 187 in recesses 188 forming additional handholds which are accessible from the lateral sides of float members 132, 132a. Float members 132, 132a have slightly different proportions than float members 22 and, as a result, do not require recesses 66 to accommodate projections 46 when stacking float members 132, 132a. Common to all of the illustrated float members 22, 132, 132a and marked in FIG. 23 are latching recesses 186 which permit a hook or bracket on strap 61 to be easily secured to the float member.

The assembly shown in FIGS. 23 and 24 include a hose clamp assembly 162 that is secured to attachment interface 95 and attached flexible hose 164 to the float assembly. Flexible hose 164 can be used to convey liquids. For example, hose 164 can be used to convey diesel fuel from a source on land to dredging equipment while the pipe on which float members 132a are mounted conveys the dredged material in the opposite direction. When using hose 164 to convey fuel, it is critical to keep hose 164 elevated above the water surface and, thus, critical that float members 132a do not rotate relative to the elongate conveyance on which float members 132a are mounted. In this regard, it is noted that while the float member 132a does not have a reinforcing structure 134 or clamping insert, hose clamp assembly 162 and hose 164 could be used with float members such as float members 22 and 132 which do include either or both reinforcing structures 134 and inserts such as rubber inserts to enhance the gripping ability of the float members.

Hose clamp assembly 162 is shown in greater detail in FIGS. 24-26 and includes a base plate 166 that is attached to attachment interface 95 by inserting fasteners 114, which may take the form of bolts with split washers, through openings 168 to engage threaded inserts 98. A fastener assembly 170 secures lower bracket 172 to base plate 166. A portion of fastener assembly 170 is disposed within central recess 97 of attachment interface 95 when assembly 162 is secured to the float member.

An upper bracket 174 is secured to lower bracket 172 with bolts 176 and nuts 178. To secure hose 164, upper bracket 174 is removed, hose 164 is positioned on lower bracket 172 and then upper bracket 174 and tightened down with bolts 176 and nuts 178. Brackets 172, 174 have a common design with openings for bolts 176 in the outwardly extending sections and holes 184 in each of their three central sections. Resilient bumpers 180 can be positioned in holes 184 to inhibit abrasion and firmly grip hose 164. Bumpers 180 include a stem 182 that is inserted through a hole 184 to attach each bumper 180.

Although the illustrated example shows the use of hose clamp assembly 162 used with a flexible fuel hose, alternative elongate objects may also be secured with hose clamp assembly 162. For example, an electrical cable or water line could be secured to a float assembly using a bracket assembly similar to assembly 162.

As evident from the discussion presented above, the illustrated float members 22, 132, 132a, include a number of features that facilitate the efficient and economical use of a float assembly 20. These features may all be employed on a single float member 22, 132, 132a as depicted in the illustrated embodiments or may be used individually or in various combinations with alternative float members.

While this invention has been described as having an exemplary design, the present invention may be further modified within the spirit and scope of this disclosure. This application is therefore intended to cover any variations, uses, or adaptations of the invention using its general principles.

What is claimed is:

1. A float assembly securable to an elongate conveyance and storable on a horizontal ground surface when not in use, the float assembly comprising:
at least one float member securable to the conveyance, the float member defining a longitudinal axis, a radially inward facing generally arcuate surface and an outward facing support surface disposed opposite the arcuate surface wherein the support surface is engageable with the ground surface to stably support the float member with the arcuate surface facing upward and wherein a plurality of float members having the same configuration as the at least one float member are nestingly stackable on the at least one float member when the support surface of the at least one float member is engaged with the ground surface.

2. The float assembly of claim 1 wherein the support surface comprises at least one substantially planar surface.

3. The float assembly of claim 1 wherein the at least one float member defines a longitudinal length and the support surface extends longitudinally for a substantial majority of the longitudinal length of the at least one float member.

4. The float assembly of claim 1 wherein the at least one float member includes at least three projections and wherein engagement of the at least three projections with the ground surface stably supports the float member on the ground surface with the arcuate surface facing downward and wherein a plurality of float members having the same configuration as the at least one float member are nestingly stackable on the at least one float member when the at least three projections of the at least one float member are engaged with the ground surface.

5. The float assembly of claim 4 wherein, when the at least three projections of the least one float member are engaged with the ground surface, the at least three projections define at least one laterally extending passage for receiving a pair of forks of a fork lift.

6. The float assembly of claim 1 wherein the radially inward facing arcuate surface defines an outwardly flaring section on each longitudinal end of the at least one float member and wherein each outwardly flaring section defines a recess adapted to be gripped by a human hand.

7. The float assembly of claim 1 wherein the at least one float member defines a plurality of clamping members each clamping member projecting radially inwardly from the arcuate surface whereby the clamping members are engageable with a cylindrical conveyance with the arcuate surface being spaced outwardly from the cylindrical conveyance.

8. The float assembly of claim 1 wherein the at least one float member defines a hollow interior and further comprises a removable cap wherein removal of the cap permits access to a hollow interior of the float member whereby ballast may be added and removed from the float member.

9. A float assembly securable to an elongate conveyance and storable on a horizontal ground surface when not in use, the float assembly comprising:
at least one float member securable to the conveyance, the float member defining a longitudinal axis, a radially inward facing generally arcuate surface and at least three projections wherein engagement of the at least three projections with the ground surface stably supports the float member on the ground surface with the arcuate surface facing downward and wherein a plurality of float members having the same configuration as the at least one float member are nestingly stackable on the at least one float member when the at least three projections of the at least one float member are engaged with the ground surface and wherein, when the at least three projections of the least one float member are engaged with the ground surface, the at least three projections define at least one laterally extending passage for receiving a pair of forks of a fork lift.

10. The float assembly of claim 9 wherein the radially inward facing arcuate surface defines an outwardly flaring section on each longitudinal end of the at least one float member and wherein each outwardly flaring section defines a recess adapted to be gripped by a human hand.

11. The float assembly of claim 9 wherein the at least one float member defines a plurality of clamping members each clamping member projecting radially inwardly from the arcuate surface whereby the clamping members are engageable with a cylindrical conveyance with the arcuate surface being spaced outwardly from the cylindrical conveyance.

12. The float assembly of claim 11 further comprising at least one removable accessory and wherein the at least one float member defines an attachment interface, the accessory being removably securable to the attachment interface.

13. The float assembly of claim 12 wherein the at least one float member further comprises an outward facing support surface disposed opposite the arcuate surface wherein the attachment interface is disposed proximate the support surface and, when the accessory is detached from the at least one float member, the support surface is engageable with the ground surface to stably support the float member with the arcuate surface facing upward and wherein a plurality of float members having the same configuration as the at least one float member are nestingly stackable on the at least one float member when the support surface of the at least one float member is engaged with the ground surface.

14. A float assembly securable to an elongate conveyance and storable on a horizontal ground surface when not in use, the float assembly comprising:
at least one float member securable to the conveyance, the float member defining a longitudinal axis and a radially inward facing generally arcuate surface wherein the at least one float member is stably positionable on the ground surface and a plurality of float members having the same configuration as the at least one float member are nestingly stackable on the at least one float member when the at least one float member is positioned on the ground surface; and
wherein the float member defines at least one handhold adapted to be gripped by a human hand.

15. The float assembly of claim 14 wherein the radially inward facing arcuate surface defines an outwardly flaring section on each longitudinal end of the at least one float member and the at least one handhold comprises a recess in each of the outwardly flaring sections.

16. The float assembly of claim 15 wherein the at least one float member and the plurality of float members stackable thereon are selectively stackable in one of two orientations wherein, in a first one of the two orientations, the arcuate surfaces of the float members face downward and, in the second one of the two orientations, the arcuate surfaces of the float members face upward.

17. A float assembly securable to an elongate, substantially cylindrical, conveyance, the float assembly comprising:
first and second float members having substantially the same configuration, the first and second float members being securable together to thereby attach the first and second float members to the conveyance, each of the first and second float members defining a longitudinal axis and a radially inward facing generally arcuate surface;
each of the first and second float members including at least one clamping member projecting radially inwardly from the arcuate surface wherein securement of the first and second float members to a conveyance engages the clamping members with the conveyance with the arcuate surfaces of the first and second float members being spaced therefrom; and
each of the first and second float members including at least one projection and at least one cooperating guide wherein the at least one projection of the first float member is engageable by the at least one cooperating guide of the second float member and the at least one projection of the second float member is engageable by the at least one cooperating guide of the first float member and wherein engagement of the projections with the cooperating guides orients the first and second float members relative to each other as the arcuate surfaces of the first and second float members are moved toward each other during securement of the first and second float members to the conveyance.

18. The float assembly of claim 17 wherein the clamping members each comprise a non-slip surface for engagement with the conveyance.

19. The float assembly of claim 18 wherein the clamping members each comprise a rubber material, the rubber material defining the non-slip surface of each clamping member.

20. The float assembly of claim 18 further comprising at least one removable accessory and wherein at least one of the first and second float members defines an attachment interface, the accessory being removably securable to the attachment interface.

21. The float assembly of claim 17 wherein each of the first and second float members defines a reinforcing structure disposed proximate at least one of the clamping members.

22. The float assembly of claim 21 wherein each of the first and second float members comprises a substantially rigid material layer defining a hollow structure and the reinforcing structure comprises a depression in the rigid material layer.

23. The float assembly of claim 17 wherein the first and second float members include a plurality of cooperating openings adapted to receive fasteners when securing the first and second float members together and wherein each of the first and second float members comprises at least one reinforcing structure disposed proximate each of the plurality of cooperating openings.

24. The float assembly of claim 17 wherein each of the first and second float members includes at least three projections and at least three cooperating guides and wherein engagement of the at least three projections of a respective one of the first and second float members with a horizontal ground surface stably supports the one float member on the ground surface with the arcuate surface facing downward and wherein a plurality of float members having the same configuration as the first and second float members are nestingly stackable on the one float member when the at least three projections of the one float member are engaged with the ground surface.

25. The float assembly of claim 24 wherein when the at least three projections of the one float member are engaged with the ground surface, the at least three projections define laterally extending passages for a pair of forks of a fork lift.

26. The float assembly of claim 24 wherein the guides are formed by guide openings in the float member, the guide openings being shaped to slidably receive the projections.

27. The float assembly of claim 17 wherein said at least one float member defines a hollow interior and further comprises a removable cap wherein removal of the cap permits access to the hollow interior for adding and removing ballast.

28. A float assembly securable to an elongate, substantially cylindrical, conveyance, the float assembly comprising:
first and second float members having substantially the same configuration, the first and second float members being securable together to thereby attach the first and second float members to the conveyance, each of the first and second float members defining a longitudinal axis and a radially inward facing generally arcuate surface;
each of the first and second float members including at least one clamping member projecting radially inwardly from the arcuate surface wherein securement of the first and second float members to a conveyance engages the clamping members with the conveyance with the arcuate surfaces of the first and second float members being spaced therefrom; each of the clamping members having a non-slip surface for engagement with the conveyance to resist rotation of the first and second float members relative to the conveyance; and
at least one removable accessory and wherein at least one of the first and second float members defines an attachment interface, the accessory being removably securable to the attachment interface.

29. The float assembly of claim 28 wherein the accessory includes an elongate support member extending outwardly from the float member.

30. The float assembly of claim 29 wherein the clamping members each comprise a rubber material, the rubber material defining the non-slip surface of each clamping member.

31. The float assembly of claim 28 wherein the accessory includes a flag mounted on an elongate support member extending outwardly from the float member.

32. The float assembly of claim 28 wherein the accessory includes a light mounted on an elongate support member extending outwardly from the float member.

33. A float assembly securable to an elongate, substantially cylindrical, conveyance, the float assembly comprising:
first and second float members having substantially the same configuration, the first and second float members being securable together to thereby attach the first and second float members to the conveyance, each of the first and second float members defining a longitudinal axis and a radially inward facing generally arcuate surface;
each of the first and second float members including at least one clamping member projecting radially inwardly from the arcuate surface wherein securement of the first and second float members to a conveyance engages the clamping members with the conveyance with the arcuate surfaces of the first and second float members being spaced therefrom; and
wherein each of the first and second float members defines a reinforcing structure disposed proximate at least one of the clamping members.

34. The float assembly of claim 33 wherein each of the first and second float members comprises a substantially rigid material layer defining a hollow structure and the reinforcing structures comprise at least one depression in the rigid material layer.

35. The float assembly of claim 34 wherein the reinforcing structures each comprise two oppositely disposed depressions, one depression formed in the arcuate surface and the other depression formed in an exterior surface of the float member.

36. The float assembly of claim 33 wherein at least a portion of an engagement surface of at least one clamping member is disposed radially inwardly of at least a portion of a respective one of the reinforcing structures.

37. The float assembly of claim 33 wherein each reinforcing structures is disposed between the arcuate surface and an exterior surface of the float member and resists relative movement of the arcuate surface and the exterior surface toward each other.

38. A float assembly securable to an elongate conveyance and storable on a horizontal ground surface when not in use, the float assembly comprising:
at least one float member securable to the conveyance stably positionable on the ground surface, the float member defining a longitudinal axis, a radially inward facing generally arcuate surface and a radially outwardly facing exterior surface having a generally arcuate shape disposed opposite the inward arcuate surface, the exterior surface defining at least one nesting recess; and
wherein a plurality of float members having the same configuration as the at least one float member are nestingly stackable on the at least one float member and wherein for each adjacent pair of stacked float members, one of the float members of the pair engages the nesting recess of the other float member of the pair to thereby stably engage the pair of adjacently stacked float members.

39. The float assembly of claim 38 wherein the nesting recess comprises a longitudinally extending recess.

40. The float assembly of claim 39 comprising a pair of symmetrically disposed longitudinally extending nesting recesses.

41. The float assembly of claim 40 wherein the at least one float member comprises a pair of longitudinally extending intermediate surfaces extending between the exterior surface and the arcuate surface; the intermediate surfaces each being engageable with one of the longitudinally extending nesting recesses of an adjacently stacked float member.

42. The float assembly of claim 41 wherein the longitudinal recess comprises a protrusion engageable with a corresponding recess in the intermediate surface of the other float member to thereby resist longitudinal movement between the pair of adjacently stacked float members.

43. The float assembly of claim 42 wherein each of the longitudinally extending nesting recesses extends for substantially the entire longitudinal length of the float member.

44. The float assembly of claim 38 wherein the at least one float member includes at least three projections and wherein engagement of the at least three projections with the ground surface stably supports the float member on the ground surface with the arcuate surface facing downward and wherein a plurality of float members having the same configuration as the at least one float member are nestingly stackable on the at least one float member when the at least three projections of the at least one float member are engaged with the ground surface and wherein the nesting recess is engageable by at least one of the projections of an adjacently stacked float member.

45. The float assembly of claim 44 wherein the at least one nesting recess further comprises a pair of symmetrically disposed nesting recesses and wherein the at least one float member comprises a pair of longitudinally extending intermediate surfaces extending between the exterior surface and the arcuate surface; the at least three projections extending from the intermediate surfaces and the intermediate surfaces each being engageable with one of the longitudinally extending nesting recesses of an adjacently stacked float member

46. The float assembly of claim 44 wherein engagement of the at least one projection with the nesting recess of an adjacently stacked float member resists both longitudinal and lateral relative movement between the adjacently stacked float members.
